(19) United States
(12) Patent Application Publication
(10) Pub. No.: US 2009/0067876 A1
(43) Pub. Date: Mar. 12, 2009

(54) IMAGE FORMING METHOD, IMAGE FORMING APPARATUS AND PROCESS CARTRIDGE

(76) Inventors: Takuya SESHITA, Hiratsuka-shi (JP); Toyoshi Sawada, Hiratsuka-shi (JP); Tomomi Suzuki, Numazu-shi (JP); Tsuneyasu Nagatomo, Numazu-shi (JP); Satoshi Kojima, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/202,797

(22) Filed: Sep. 2, 2008

(30) Foreign Application Priority Data
Sep. 10, 2007 (JP) 2007-234038
Jul. 10, 2008 (JP) 2008-180505

(51) Int. Cl. G03G 15/00

(52) U.S. Cl. 399/107

(57) ABSTRACT

An image forming method, including charging the surface of an image bearer with a charger; irradiating the charged surface of the image bearer to form a latent image; developing the latent image with a toner to form a visible toner image; transferring the toner image onto a transfer medium directly or through an intermediate transferer; removing the toner remaining on the surface of the image bearer with a cleaning blade; applying a lubricant to the surface of the image bearer; and fixing the toner image on the transfer medium, wherein the toner is a water-granulated toner having the following properties (1) to (4):

(1) a volume-average particle diameter of from 3.0 to 7.0 μm; (2) an average shape factor SF-1 of from 120 to 160; (3) an average shape factor SF-2 of from 100 to 140; and (4) a BET specific surface area of from 2.5 to 7.0 m²/g.

### BACKGROUND OF THE INVENTION

1. Field of the Invention

The present invention relates to an electrophotographic image forming method and an electrophotographic image forming apparatus applicable to image forming apparatuses such as copiers and printers, and more particularly to an image forming method (image forming apparatus) including a transfer process (transferer) directly or indirectly transferring a toner image formed on an image bearer onto a recording paper, a cleaning process (cleaner) cleaning the surface of the image bearer and a lubricant application process (lubricator) applying a lubricant to the surface of the image bearer.

2. Discussion of the Background

Electrophotographic image forming methods include, e.g., as an image forming apparatus in FIG. 12 shows, evenly charging an image forming area on the surface of an image bearer 8 with a charger 1, writing on the image bearer 8 with an irradiator 2 and forming an image on the image bearer 8 with an image developer 3 using a frictionally-charged toner, then transferring the image on the image bearer 8 with a transferer 4 onto a recording paper fed from a paper feeder 9 directly or indirectly through an intermediate transferer (not shown) and fixing the image on the recording paper with a fixer 10.

Corotron or scorotron chargers using corona discharge have been conventionally used as the charger 1 charging the image bearer 8. However, chargers using the corona discharge generate much ozone and NOx adhering to the image bearer 8, resulting in problems of image deletion as time passes. In addition, a high-voltage power source capable of applying a high voltage of from 5 to 10 kV to the charge wire is needed to perform a corona discharge, which has made it difficult to reduce cost of image forming apparatuses.

Recently, many chargers not using the corona discharge such as contact charges contacting the image bearer and proximity charges located close thereto are being used. Although the contact charges and the proximity charges (charging rollers are typically used, and chargeable charging members such as fur brushes, magnetic brushes and blades are occasionally used) solves many problems of chargers using the corona discharge, image bearers are abraded more and have shorter lives. Further, an AC voltage causes noises. In addition, the chargers rub toners and paper powders against the image bearers, resulting in further contamination of the surfaces thereof and of the chargers.

Developers used in the image developers include a two-component developer formed of a toner and a carrier, and a one-component developer formed of a magnetic or a non-magnetic toner. These toners are typically prepared by kneading and pulverizing methods of melting and kneading a resin, a pigment, a charge controlling agent and a release agent to prepare a kneaded mixture, cooling the kneaded mixture to prepare a solidified mixture, pulverizing the solidified mixture to prepare a pulverized mixture and classifying the pulverized mixture. However, the methods have difficulty in unifying the particle diameter and the form of a toner.

Therefore, lately aqueous toner granulation methods such as emulsion polymerization methods and dissolution suspension methods intently controlling the particle diameter are often used to solve the problems.

Recently, toners are required to have smaller and uniform particle diameters to produce images having higher quality, particularly full-color images having higher definition. This is because a fine powder toner of a toner having a wide particle diameter distribution contaminates a developing sleeve, a contact or proximity charger, a cleaning blade, photoreceptor (image bearer) and carrier, or scatters, resulting in inability to produce images having both high quality and high reliability. On the contrary, a toner having a uniform particle diameter and a sharp particle diameter distribution increases its developing behavior and largely improves its fine dot reproducibility.

However, a water-granulated spherical toner has a problem in its cleanability. Particularly, a cleaning blade is incapable of stably removing a (residual) toner remaining on an image bearer. Namely, such a spherical residual toner remaining on the surface thereof after a toner image is transferred onto a recording paper or the like is likely to scrape through a gap between the surface of the photoreceptor and the cleaning blade even when removed with the cleaning blade, resulting in poor cleaning of the residual toner on the surface thereof. The poor cleaning of the spherical toner is thought to have a hypothetical mechanism that adherence and resistivity between the spherical toner and the photoreceptor generates a rotary drive force the moment when the spherical toner contacts the insulative cleaning blade, causing the toner to scrape through a gap between the photoreceptor and the blade while rotating.

There are a variety of methods of improving the cleanability such as innovative methods of preparing toners and constituents thereof. One of them is to deform the spherical toner. The deformed toner can be held back by the blade and cleaned thereby. However, when too deformed, the toner unstably behaviors, resulting in deterioration of fine dot reproducibility. Therefore, a shape distribution of the toner needs to be most suitably designed to have good transfer quality, transfer efficiency and cleanability.

Japanese published unexamined application No. 6-317928 does not disclose cleanability, but discloses a toner having a specified saturated magnetization and satisfying the following relationships after pulverized and heated produces high density and low foggy quality images (left column line 31 on page 4):

Sb×Dv×Hb=6.0

6≦Sb×Dv×Hb≦30

wherein Sb represents a specific surface area (m²/g), Dv represents a volume-average particle diameter and Hb represent s specific gravity (g/cm³).

By the way, most of the electrophotographic image forming apparatuses use only blades as cleaners. In addition, some high-speed image forming apparatuses have cleaning auxiliary means to prevents toners from partially adhering to the cleaning blades much. These are located at upstream sides of the cleaners and mechanically stir the toners entering the cleaners to improve the cleanabilities.

Under these circumstances, a water-granulated toner is desired to produce higher-quality images, although being difficult to have cleanability. Therefore, image bearers have lubricators in many cases such that a toner has sufficient cleanability, the surface of the image bearer is protected and filming is prevented when using a toner having high sphericity.

Japanese published unexamined application No. 1-257857 does not disclose lubricant application, but discloses a fine particulate toner prepared by soap-free emulsion polymerization methods or the like has good chargeability, fixability, cleanability and heat resistance (right column line 5 to left column last line on page 2).

Japanese published unexamined applications Nos. 2002-244516, 2002-156877, 2002-55580, 2002-244487, 2002-229227, etc. disclose many lubricators.

When a charger discharging at a microscopic spacial gap between an image bearer and the charger, a lubricant is essentially applied to the surface of the image bearer in terms of image quality, cleanability and protection of the surface thereof. In addition, an image forming apparatus having a longer life needs to prevent the cleaning blade from being abraded due to increase of surface resistivity of the image bearer when the lubricant is deteriorated. Means of preventing the cleaning blade from being abraded are thought to include three means, i.e., (1) preventing the lubricant from being deteriorated, (2) providing a cleaning blade hard to abrade even when the surface resistivity of an image bearer increases, (3) removing a deteriorated lubricant from the surface of an image bearer, etc.

On the other hand, when a charger not discharging at a microscopic spacial gap between an image bearer and the charger, a lubricant is essentially applied to the surface of the image bearer in terms of image quality, but the lubricant on the surface of an image bearer is not deteriorated and the abrasion of the cleaning blade is reduced, and therefore an image forming apparatus using such a charger as corona chargers has a longer life. However, the chargers generate ozone O₃ and NOx, and particularly discharge products such as NOx adhere to the surface of an image bearer to deteriorate image quality. Namely, the following there means are thought to stably produce quality images:

(1) preventing the discharge products from adhering to an image bearer;

(2) using an image forming method even when the discharge products adhere thereto;

(3) removing the discharge products adhering to the surface of an image bearer therefrom, etc.

When whichever charger is used, it is essential to remove foreign particles (the deteriorated lubricant or the discharge products) from the surface of an image bearer to stably produce quality images. Japanese published unexamined application No. 2002-162881 discloses an image forming apparatus including a discharge product remover contacting the surface of an image nearer to hold back the discharge product and absorbing a part of thereof, and removing the discharge products held back with a cleaning blade. The remover is formed of a metallic core, an elastic hydroscopic member on the metallic core and a highly-water-absorbing member sealing the elastic hydroscopic member on the metallic core (paragraph [0027]). Japanese published unexamined application No. 2004-20660 discloses an image forming apparatus including an intermediate transferer contactor and separator contacting and separating an intermediate transferer a toner image is intermediately transferred onto transferred to and from an image bearer rotating of a specified image forming unit selected by the intermediate transferer contactor and separator, and removing foreign particles from another image bearer with a remover while the specified image forming unit forms images (paragraph [0010]).

Because of these reasons, a need exists for an image forming method and an image forming apparatus using a desired charger and a water-granulated toner, capable of removing foreign particles such as deteriorated lubricants and discharge products from the surface of an image bearer, constantly maintaining a fresh surface thereof, and stably producing quality images with a long life.

### SUMMARY OF THE INVENTION

Accordingly, an object of the present invention is to provide an image forming method using a desired charger and a water-granulated toner, capable of removing foreign particles such as deteriorated lubricants and discharge products from the surface of an image bearer, constantly maintaining a fresh surface thereof, and stably producing quality images with a long life.

Another object of the present invention is to provide an image forming apparatus using the image forming method.

A further object of the present invention is to provide a process cartridge used in the image forming apparatus.

These objects and other objects of the present invention, either individually or collectively, have been satisfied by the discovery of an image forming method, comprising:

charging the surface of an image bearer;

irradiating the charged surface of the image bearer to form a latent image;

developing the latent image with a toner to form a visible toner image;

transferring the toner image onto a transfer medium directly or through an intermediate transferer;

removing the toner remaining on the surface of the image bearer with a cleaning blade;

applying a lubricant to the surface of the image bearer; and

fixing the toner image on the transfer medium,

wherein the toner is a water-granulated toner having the following properties (1) to (4):

(1) a volume-average particle diameter of from 3.0 to 7.0 μm;

(2) an average shape factor SF-1 of from 120 to 160;

(3) an average shape factor SF-2 of from 100 to 140; and

(4) a BET specific surface area of from 2.5 to 7.0 m²/g.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the image forming apparatus of the present invention;

FIG. 2 is a schematic view illustrating another embodiment of the image forming apparatus of the present invention;

FIG. 3 is a schematic view illustrating a further embodiment of the image forming apparatus of the present invention;

FIG. 4 is a schematic view illustrating another embodiment of the image forming apparatus of the present invention;

FIG. 5 is a schematic view illustrating a further embodiment of the image forming apparatus of the present invention;

FIG. 6 is a schematic view illustrating another embodiment of the image forming apparatus of the present invention;

FIG. 7 is a schematic view illustrating a further embodiment of the image forming apparatus of the present invention;

FIG. 8 is a schematic view illustrating an embodiment of the process cartridge of the present invention;

FIGS. 9A and 9B are schematic views for explaining shape factors SF-1 and SF-2;

FIG. 10 is a schematic view illustrating embodiments of layer structures of an amorphous silicon photoreceptor;

FIG. 11 is a thin line image chart used in Examples;

FIG. 12 is a schematic view illustrating a conventional image forming apparatus; and

FIG. 13 is a schematic view illustrating another embodiment of the image forming apparatus of the present invention.

### DETAILED DESCRIPTION OF THE INVENTION

The present invention provides an image forming method using a desired charger and a water-granulated toner, capable of removing foreign particles such as deteriorated lubricants and discharge products from the surface of an image bearer, constantly maintaining a fresh surface thereof, and stably producing quality images with a long life.

More particularly, the present invention relates to an image forming method, comprising:

charging the surface of an image bearer;

irradiating the charged surface of the image bearer to form a latent image;

developing the latent image with a toner to form a visible toner image;

transferring the toner image onto a transfer medium directly or through an intermediate transferer;

removing the toner remaining on the surface of the image bearer with a cleaning blade;

applying a lubricant to the surface of the image bearer; and

fixing the toner image on the transfer medium,

wherein the toner is a water-granulated toner having the following properties (1) to (4):

(1) a volume-average particle diameter of from 3.0 to 7.0 μm;

(2) an average shape factor SF-1 of from 120 to 160;

(3) an average shape factor SF-2 of from 100 to 140; and

(4) a BET specific surface area of from 2.5 to 7.0 m²/g.

Water-granulated toners mostly have spherical shapes and produce high-quality images, but cause poor cleaning. Therefore, it is necessary to apply a lubricant to an image bearer to improve cleanability. However, when a lubricant is applied to the surface of an image bearer, a proximity or a contact charger discharging at a microscopic spacial gap between the charger and the image bearer deteriorates the surface of the lubricant and the resistivity thereof increases, resulting in acceleration of abrasion of a cleaning blade. Therefore, a system using the proximity or the contact charger discharging at a microscopic spacial gap between the charger and an image bearer cannot stably be used for long periods unless the deteriorated lubricant on the surface of the image bearer is removed. Meanwhile, a system using a charger such as corona chargers not discharging at a microscopic spacial gap between the charger and an image bearer prevents a cleaning blade from being quickly abraded, but cannot stably produce high-quality images for long periods unless removing discharge products accumulated on the image bearer.

The present inventors found that a discharge product (deteriorated lubricant) on the surface of an image bearer can be removed when a corona (proximity) charger is used in forming images with a water-granulated toner if a cleaning process cleaning a residual toner remaining on the surface of the image bearer after transferred with a cleaning blade and a lubricant applying process applying a lubricant thereto are included after a transfer process, and the water-granulated toner has a BET specific surface area in a specified scope.

Namely, when a toner image is formed with a water-granulated toner having a BET specific surface area of from 2.5 to 7.0 m²/g on an image bearer, a discharge product generated by a charger such as corona chargers not discharging at a microscopic spacial gap between the charger and an image bearer is absorbed to the toner. When the toner is removed from the image bearer in the transfer or the cleaning process, the discharge product is removed as well at the same time. In addition, when a proximity charger discharging at a microscopic spacial gap between the charger and an image bearer is used, the deteriorated lubricant on the surface of the image bearer is removed at the same time when the toner is removed from the image bearer in the transfer or the cleaning process.

In this case, the toner needs to have a volume-average particle diameter of from 3.0 to 7.0 μm, an average shape factor SF-1 of from 120 to 160 and an average shape factor SF-2 of from 100 to 140. The volume-average particle diameter (Dv) is preferably from 3.0 to 5.5 μm, and more preferably from 5.0 to 5.5 μm.

When the BET specific surface area is less than 2.5 m²/g, the discharge product is not sufficiently removed and accumulated on the surface of an image bearer, resulting in abnormal images. When greater than 7.0 m²/g, the resultant image quality noticeably deteriorates and such a toner cannot be used.

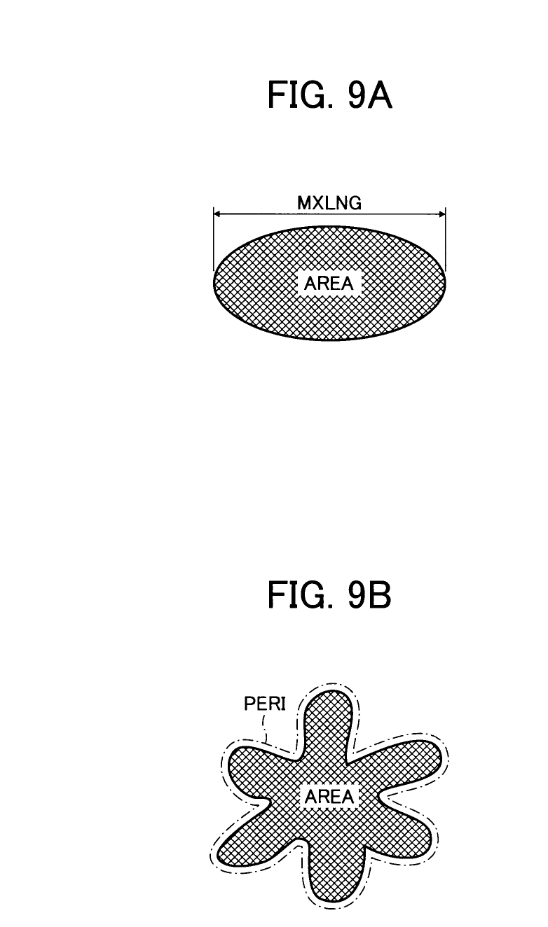

FIGS. 9A and 9B are schematic views for explaining shape factors SF-1 and SF-2. The shape factor SF-1 represents a degree of roundness of a toner, and is determined in accordance with the following formula (1):

SF-1={(MXLNG)²/AREA}×(100π/4) (1)

wherein MXLNG represents an absolute maximum length of a particle and AREA represents a projected area thereof.

When the SF-1 is 100, the toner has the shape of a complete sphere. As SF-1 becomes greater, the toner becomes more amorphous.

SF-2 represents the concavity and convexity of the shape of the toner, and specifically a square of a peripheral length of an image projected on a two-dimensional flat surface (PERI) is divided by an area of the image (AREA) and multiplied by 100 π/4 to determine SF-2 as the following formula (2) shows.

SF-2={(PERI)²/AREA}×(100π/4) (2)

When SF-2 is 100, the surface of the toner has less concavities and convexities. As SF-2 becomes greater, the concavities and convexities thereon become more noticeable.

SF-1 and SF-2 (shape factors) for use in the present invention are determined by the following formulae after photographing 300 particles of the toner with an FE-SEM (S-4200) from Hitachi, Ltd. and analyzing the photographed image with an image analyzer Luzex AP from NIRECO Corp through an interface. SF-1 and SF-2 are preferably determined by using the S-4200 and Luzex AP, but are not limited thereto provided similar results can be obtained.

When the shape of a toner is close to a sphere, the toner contacts the other toner or a photo receptor at a point. Therefore, the toners adhere less each other and have higher fluidity. In addition, the toner and the photoreceptor less adhere to each other, and transferability of the toner improves. When SF-1 or SF-2 is more than 180, the transferability thereof deteriorates.

The BET specific surface B (m²/g) can be measured according to a BET method using a specific surface measurer AUTOSORB 1 (NOVA series from Yuasa Ionics, Inc.) applicable to JIS standards Z8830 and R1626, wherein nitrogen gas is absorbed on a surface of the sample using a BET multipoint method.

Further, the toner is prepared from a solution or a dispersion including at least an organic solvent, a binder resin, a prepolymer formed of modified polyester resins, a compound elongatable or crosslinkable with the prepolymer, a colorant, a release agent and a layered inorganic mineral (organic-modified clay), the metallic cation of which is at least partially modified with an organic cation. The solid content of the toner preferably includes the layered inorganic mineral in an amount of from 0.05 to 10% b weight. When less than 0.05% by weight, the solution or the dispersion may not have a targeted Casson yield value. When greater than 10% by weight, the fixability of the resultant toner possibly deteriorates.

The solution or the dispersion preferably has a Casson yield value of from 1 to 100 pa at 25° C., and the toner is preferably prepared by subjecting the solution or the dispersion to a crosslinking and/or an elongation reaction to prepare a dispersion and removing the solvent therefrom. When the Casson value is less than 1 Pa, the resultant toner is difficult to have a targeted form. When greater than 100 Pa, the productivity possibly deteriorates.

The above-mentioned method can easily prepare a mother toner having a volume-average particle diameter of from 3.0 to 7.0 μm, an average shape factor SF-1 of from 120 to 160, an average shape factor SF-2 of from 100 to 140 and a BET specific surface area of from 2.5 to 7.0 m²/g. Even when an external additive is externally added to the mother toner, the resultant toner has a BET specific surface area of from 2.5 to 7.0 m²/g.

The layered inorganic mineral (organic-modified clay), the metallic cation of which is at least partially modified with an organic cation includes an organic-modified montmorillonite and an organic-modified smectite.

Specific examples of an organic cation modifier imparting an organic cation include a quaternary alkyl ammonium salt, a phosphonium salt, an imidazolium salt, etc., and the quaternary alkyl ammonium salt is preferably used. Specific examples thereof include trimethylstearylammonium, dimethylstearylbenzylammonium, dimethyloctadecylammonium, oleylbis(2-hydroxylethyl)methylammonium, etc.

The Casson yield value can be measured by a high shear viscometer. The measurement conditions are as follows:
apparatus: AR2000 from TA Instruments;
shear stress: 120 Pa/5 min;
geometry: 40 mm steel plate;
geometry gap: 1 mm; and
analysis software: TA DATA ANALYSIS (from TA Instruments).

Hereinafter, the toner constituents and methods of preparing the toner will be explained.

The toner for use in the image forming method of the present invention is prepared by crosslinking and/or elongating a toner constituent liquid formed of an organic solvent, and at least a polyester prepolymer having a functional group including a nitrogen atom, a polyester resin, a colorant and a release agent dispersed therein in an aqueous solvent.

The polyester resin is formed by a polycondensation reaction between a polyol and a polycarboxylic acid.

As the polyol (PO), diol (DIO) and polyol having 3 valences or more (TO) can be used, and DIO alone or a mixture of DIO and a small amount of TO is preferably used. Specific examples of DIO include alkylene glycol such as ethylene glycol, 1,2-propylene glycol, 1,3-propylene glycol, 1,4-butanediol, and 1,6-hexanediol; alkylene ether glycol such as diethylene glycol, triethylene glycol, dipropylene glycol, polyethylene glycol, polypropylene glycol and polytetramethylene ether glycol; alicyclic diol such as 1,4-cyclohexanedimethanol and hydrogenated bisphenol A; bisphenol such as bisphenol A, bisphenol F and bisphenol S; adducts of the above-mentioned alicyclic diol with an alkylene oxide such as ethylene oxide, propylene oxide and butylene oxide; and adducts of the above-mentioned bisphenol with an alkylene oxide such as ethylene oxide, propylene oxide and butylene oxide. In particular, alkylene glycol having 2 to 12 carbon atoms and adducts of bisphenol with an alkylene oxide are preferably used, and a mixture thereof is more preferably used.

Specific examples of TO include multivalent aliphatic alcohol having 3 to 8 or more valences such as glycerin, trimethylolethane, trimethylolpropane, pentaerythritol and sorbitol; phenol having 3 or more valences such as trisphenol PA, phenolnovolak, cresolnovolak; and adducts of the above-mentioned polyphenol having 3 or more valences with an alkylene oxide.

As the polycarboxylic acid (PC), dicarboxylic acid (DIC) and polycarboxylic acid having 3 or more valences (TC) can be used. DIC alone, or a mixture of DIC and a small amount of TC are preferably used. Specific examples of DIC include alkylene dicarboxylic acids such as succinic acid, adipic acid and sebacic acid; alkenylene dicarboxylic acid such as maleic acid and fumaric acid; and aromatic dicarboxylic acids such as phthalic acid, isophthalic acid, terephthalic acid and naphthalene dicarboxylic acid. In particular, alkenylene dicarboxylic acid having 4 to 20 carbon atoms and aromatic dicarboxylic acid having 8 to 20 carbon atoms are preferably used.

Specific examples of TC include aromatic polycarboxylic acids having 9 to 20 carbon atoms such as trimellitic acid and pyromellitic acid. PC can be formed from a reaction between the PO and the above-mentioned acids anhydride or lower alkyl ester such as methyl ester, ethyl ester and isopropyl ester.

PO and PC are mixed such that an equivalent ratio ([OH]/[COOH]) between a hydroxyl group [OH] and a carboxylic group [COOH] is typically from 2/1 to 1/1, preferably from 1.5/1 to 1/1, and more preferably from 1.3/1 to 1.02/1.

Polyol (PO) and polycarboxylic acid (PC) are heated at a temperature of from 150 to 280° C. in the presence of a known catalyst such as tetrabutoxy titanate and dibutyltinoxide. Then, water generated is removed, under a reduced pressure if desired, to prepare a polyester resin having a hydroxyl group. The polyester resin preferably has a hydroxyl value not less than 5 mg KOH/g and an acid value of from 1 to 30 mg KOH/g, and more preferably from 5 to 20 mg KOH/g. Such a polyester resin tends to be negatively charged, and the resultant toner has good affinity with a paper and low temperature fixability thereof is improved. However, when the acid value is greater than 30 mg KOH/g, chargeability of the resultant toner deteriorates particularly due to an environmental variation.

The polyester resin preferably has a weight-average molecular weight of from 10,000 to 400,000, and more preferably from 20,000 to 200,000. When less than 10,000, the offset resistance of the resultant toner deteriorates. When greater than 400,000, the low temperature fixability thereof deteriorates.

Besides the above-mentioned unmodified polyester resin (PE) formed by the polycondensation reaction, a urea-modified polyester resin (UMPE) is preferably included in the toner. The urea-modified polyester (UMPE) is formed from a reaction between a polyester prepolymer having an isocyanate group (A) and amines (B) used as a crosslinker and/or an elongation agent. The polyester prepolymer (A) can be formed from a reaction between polyester having an active hydrogen atom formed by polycondensation between polyol (PO) and a polycarboxylic acid, and polyisocyanate (PIC).

Specific examples of the PIC include aliphatic polyisocyanate such as tetramethylenediisocyanate, hexamethylenediisocyanate and 2,6-diisocyanatemethylcaproate; alicyclic polyisocyanate such as isophoronediisocyanate and cyclohexylmethanediisocyanate; aromatic diisocyanate such as tolylenedisocyanate and diphenylmethanediisocyanate; aroma aliphatic diisocyanate such as α, α, α′, α′-tetramethylxylylenediisocyanate; isocyanurate; the above-mentioned polyisocyanate blocked with phenol derivatives, oxime and caprolactam; and their combinations.

The PIC is mixed with polyester such that an equivalent ratio ([NCO]/[OH]) between an isocyanate group [NCO] and polyester having a hydroxyl group [OH] is typically from 5/1 to 1/1, preferably from 4/1 to 1.2/1 and more preferably from 2.5/1 to 1.5/1. When [NCO]/[OH] is greater than 5, low temperature fixability of the resultant toner deteriorates. When [NCO] has a molar ratio less than 1, a urea content in ester of the modified polyester decreases and hot offset resistance of the resultant toner deteriorates.

The content of the constitutional component of a polyisocyanate in the polyester prepolymer (A) having a polyisocyanate group at its end portion is from 0.5 to 40% by weight, preferably from 1 to 30% by weight and more preferably from 2 to 20% by weight. When the content is less than 0.5% by weight, hot offset resistance of the resultant toner deteriorates, and in addition, the heat resistance and low temperature fixability of the toner also deteriorate. In contrast, when the content is greater than 40% by weight, low temperature fixability of the resultant toner deteriorates.

The number of the isocyanate groups included in a molecule of the polyester prepolymer (A) is at least 1, preferably from 1.5 to 3 on average, and more preferably from 1.8 to 2.5 on average. When the number of the isocyanate group is less than 1 per 1 molecule, the molecular weight of the urea-modified polyester decreases and hot offset resistance of the resultant toner deteriorates.

Specific examples of the amines (B) include diamines (B1), polyamines (B2) having three or more amino groups, amino alcohols (B3), amino mercaptans (B4), amino acids (B5) and blocked amines (B6) in which the amines (B1-B5) mentioned above are blocked.

Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc.

Specific examples of the polyamines (B2) having three or more amino groups include diethylene triamine, triethylene tetramine.

Specific examples of the amino alcohols (B3) include ethanol amine and hydroxyethyl aniline.

Specific examples of the amino mercaptan (B4) include aminoethyl mercaptan and aminopropyl mercaptan. Specific examples of the amino acids (B5) include amino propionic acid and amino caproic acid.

Specific examples of the blocked amines (B6) include ketimine compounds which are prepared by reacting one of the amines B1-B5 mentioned above with a ketone such as acetone, methyl ethyl ketone and methyl isobutyl ketone; oxazoline compounds, etc.

Among these compounds, diamines (B1) and mixtures in which a diamine is mixed with a small amount of a polyamine (B2) are preferably used.

The mixing ratio (i.e., a ratio [NCO]/[NHx]) of the content of the prepolymer (A) having an isocyanate group to the amine (B) is from 1/2 to 2/1, preferably from 1.5/1 to 1/1.5 and more preferably from 1.2/1 to 1/1.2. When the mixing ratio is greater than 2 or less than 1/2, molecular weight of the urea-modified polyester decreases, resulting in deterioration of hot offset resistance of the resultant toner.

The UMPE may include an urethane bonding as well as a urea bonding. The molar ratio (urea/urethane) of the urea bonding to the urethane bonding is from 100/0 to 10/90, preferably from 80/20 to 20/80 and more preferably from 60/40 to 30/70. When the content of the urea bonding is less than 10%, hot offset resistance of the resultant toner deteriorates.

The UMPE can be produced by a method such as a one-shot method. Polyol (PO) and polycarboxylic acid (PC) are heated at a temperature of from 150 to 280° C. in the presence of a known catalyst such as tetrabutoxy titanate and dibutyltinoxide. Then, water generated is removed, under a reduced pressure if desired, to prepare a polyester resin having a hydroxyl group. Next, polyisocyanate is reacted with the polyester resin having a hydroxyl group at from 40 to 140° C. to prepare a polyester prepolymer (A) having an isocyanate group. Further, amines (B) are reacted with the polyester prepolymer (A) at from 0 to 140° C. to prepare a urea-modified polyester.

When polyisocyanate, and A and B are reacted, a solvent can be used if desired. Suitable solvents include solvents which do not react with polyisocyanate (PIC). Specific examples of such solvents include aromatic solvents such as toluene and xylene; ketones such as acetone, methyl ethyl ketone and methyl isobutyl ketone; esters such as ethyl acetate; amides such as dimethylformamide and dimethylacetoaminde; ethers such as tetrahydrofuran.

The molecular weight of the urea-modified polyesters can optionally be controlled using are action terminator. Specific examples of the reaction terminator include monoamines such as diethyle amine, dibutyl amine, butyl amine and lauryl amine, and blocked amines, i.e., ketimine compounds prepared by blocking the monoamines mentioned above.

The weight-average molecular weight of the modified polyester of the UMPE is not less than 10,000, preferably from 20,000 to 10,000,000 and more preferably from 30,000 to 1,000,000. When the weight-average molecular weight is less than 10,000, hot offset resistance of the resultant toner deteriorates. The number-average molecular weight of the modified polyester of the UMPE is not particularly limited when the unmodified polyester resin (PE) is used in combination. Namely, the weight-average molecular weight of the UMPE resins has priority over the number-average molecular weight thereof. However, when the UMPE is used alone, the number-average molecular weight is from 2,000 to 15,000, preferably from 2,000 to 10,000 and more preferably from 2,000 to 8,000. When the number-average molecular weight is greater than 20,000, the low temperature fixability of the resultant toner deteriorates, and in addition the glossiness of full color images deteriorates.

In the present invention, not only the modified polyester of the UMPE alone but also the PE can be included as a toner binder with the UMPE. A combination thereof improves low temperature fixability of the resultant toner and glossiness of color images produced thereby, and the combination is more preferably used than using the UMPE alone. The PE may include a polyester resin modified by a chemical bonding besides urea bonding.

It is preferable that the UMPE at least partially mixes with the PE to improve the low temperature fixability and hot offset resistance of the resultant toner. Therefore, the UMPE preferably has a structure similar to that of the PE.

A mixing ratio (UMPE/PE) between the UMPE and PE is from 5/95 to 80/20, preferably from 5/95 to 30/70, more preferably from 5/95 to 25/75, and even more preferably from 7/93 to 20/80. When the UMPE is less than 5%, the hot offset resistance deteriorates, and in addition, it is disadvantageous to have both high temperature preservability and low temperature fixability.

The binder resin including the UMPE and the PE preferably has a glass transition temperature (Tg) of from 45 to 65° C., and preferably from 45 to 60°0. C. When the glass transition temperature is less than 405C, the heat resistance of the toner deteriorates. When higher than 65° C., the low temperature fixability deteriorates.

Since the UMPE is present at the surface of a toner, the toner has better heat-resistant preservability than known toners including a polyester resin as a binder resin even though the glass transition temperature is low.

Specific examples of the colorant for use in the present invention include any known dyes and pigments such as carbon black, Nigrosine dyes, black iron oxide, NAPHTHOL YELLOWS, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromiumoxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination.

The toner preferably includes the colorant in an amount of from 1 to 15% by weight, and more preferably from 3 to 10% by weight.

The colorant for use in the present invention can be used as a master batch pigment when combined with a resin.

Specific examples of the resin for use in the master batch pigment or for use in combination with master batch pigment include the modified and unmodified polyester resins mentioned above; styrene polymers and substituted styrene polymers such as polystyrene, poly-p-chlorostyrene and polyvinyltoluene; styrene copolymers such as styrene-p-chlorostyrene copolymers, styrene-propylene copolymers, styrene-vinyltoluene copolymers, styrene-vinylnaphthalene copolymers, styrene-methyl acrylate copolymers, styrene-ethyl acrylate copolymers, styrene-butyl acrylate copolymers, styrene-octyl acrylate copolymers, styrene-methyl methacrylate copolymers, styrene-ethyl methacrylate copolymers, styrene-butyl methacrylate copolymers, styrene-methyl α-chloromethacrylate copolymers, styrene-acrylonitrile copolymers, styrene-vinyl methyl ketone copolymers, styrene-butadiene copolymers, styrene-isoprene copolymers, styrene-acrylonitrile-indene copolymers, styrene-maleic acid copolymers and styrene-maleic acid ester copolymers; and other resins such as polymethyl methacrylate, polybutylmethacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These resins are used alone or in combination.

The toner of the present invention may optionally include a charge controlling agent. Specific examples of the charge controlling agent include any known charge controlling agents such as Nigrosine dyes, triphenylmethane dyes, metal complex dyes including chromium, chelate compounds of molybdic acid, Rhodamine dyes, alkoxyamines, quaternary ammonium salts (including fluorine-modified quaternary ammonium salts), alkylamides, phosphor and compounds including phosphor, tungsten and compounds including tungsten, fluorine-containing activators, metal salts of salicylic acid, salicylic acid derivatives, etc. Specific examples of the marketed products of the charge controlling agents include BONTRON 03 (Nigrosine dyes), BONTRON P-51 (quaternary ammonium salt), BONTRON S-34 (metal-containing azo dye), E-82 (metal complex of oxynaphthoic acid), E-84 (metal complex of salicylic acid), and E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE PSY VP2038 (quaternary ammonium salt), COPY BLUE (triphenyl methane derivative), COPY CHARGE NEG VP2036 and NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments and polymers having a functional group such as a sulfonate group, a carboxyl group, a quaternary ammonium group, etc.

The content of the charge controlling agent is determined depending on the species of the binder resin used, whether or not an additive is added and toner manufacturing method (such as dispersion method) used, and is not particularly limited. However, the content of the charge controlling agent is typically from 0.1 to 10 parts by weight, and preferably from 0.2 to 5 parts by weight, per 100 parts by weight of the binder resin included in the toner. When the content is too high, the toner has too large charge quantity, and thereby the electrostatic force of a developing roller attracting the toner increases, resulting in deterioration of the fluidity of the toner and decrease of the image density of toner images.

The toner of the present invention may optionally include a release agent. A wax having a low melting point of from 50 to 120° C. is effectively used as the release agent. When such a wax is included in the toner, the wax is dispersed in the binder resin and serves as a release agent at a location between a fixing roller and the toner particles. Thereby, hot offset resistance can be improved without applying an oil to the fixing roller used. Specific examples of the release agent include natural waxes such as vegetable waxes, e.g., carnauba wax, cotton wax, Japan wax and rice wax; animal waxes, e.g., bees wax and lanolin; mineral waxes, e.g., ozokelite and ceresine; and petroleum waxes, e.g., paraffin waxes, microcrystalline waxes and petrolatum. In addition, synthesized waxes can also be used. Specific examples of the synthesized waxes include synthesized hydrocarbon waxes such as Fischer-Tropsch waxes and polyethylene waxes; and synthesized waxes such as ester waxes, ketone waxes and ether waxes. In addition, fatty acid amides such as 1,2-hydroxylstearic acid amide, stearic acid amide and phthalic anhydride imide; and low molecular weight crystalline polymers such as acrylic homopolymer and copolymers having a long alkyl group in their side chain, e.g., poly-n-stearyl methacrylate, poly-n-laurylmethacrylate and n-stearyl acrylate-ethyl methacrylate copolymers, can also be used.

The content of the release agent is determined depending on the species of the binder resin used, whether or not an additive is added and toner manufacturing method (such as dispersion method) used, and is not particularly limited. However, the content of the release agent is typically from 1 to 15 parts by weight, and preferably from 3 to 10 parts by weight, per 100 parts by weight of the binder resin included in the toner.

These charge controlling agent and release agent can be kneaded together with a master batch pigment and resin. In addition, the charge controlling agent and release agent can be added when such toner constituents are dissolved or dispersed in an organic solvent.

The toner of the present invention can be prepared by the following method, but the method is not limited thereto.

1) The colorant, unmodified polyester, polyester prepolymer having an isocyanate group and release agent are dispersed in an organic solvent to prepare a toner constituent liquid.

The solvent is preferably volatile and has a boiling point lower than 100° C. because of easily removed from the dispersion after mother toner particles are formed. Specific examples of such a solvent include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. These solvents can be used alone or in combination. Among these solvents, aromatic solvents such as toluene and xylene; and halogenated hydrocarbons such as methylene chloride, 1,2-dichloroethane, chloroform, and carbon tetrachloride are preferably used. The addition quantity of such a solvent is from 0 to 300 parts by weight, preferably from 0 to 100, and more preferably from 25 to 70 parts by weight, per 100 parts by weight of the prepolymer (A) used.

2) The toner constituent liquid is emulsified in an aqueous medium under the presence of a surfactant and a particulate resin. The aqueous medium includes water alone and mixtures of water with a solvent which can be mixed with water. Specific examples of the solvent include alcohols such as methanol, isopropanol and ethylene glycol; dimethylformamide; tetrahydrofuran; cellosolves such as methyl cellosolve; and lower ketones such as acetone and methyl ethyl ketone.

The content of the aqueous medium to 100 parts by weight of the toner constituent liquid is typically from 50 to 2,000 parts by weight, and preferably from 100 to 1,000 parts by weight. When the content is less than 50 parts by weight, the dispersion of the toner constituents in the aqueous medium is not satisfactory, and thereby the resultant mother toner particles do not have a desired particle diameter. In contrast, when the content is greater than 2,000, the production cost increases.

In order to improve the dispersion in the aqueous medium, a dispersant such as a surfactant and a particulate resin is added thereto if desired.

Specific examples of the surfactant include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di(octylaminoethyle)glycin, and N-alkyl-N,N-dimethylammonium betaine.

A surfactant having a fluoroalkyl group can prepare a dispersion having good dispersibility even when a small amount of the surfactant is used. Specific examples of anionic surfactants having a fluoroalkyl group include fluoroalkyl carboxylic acids having from 2 to 10 carbon atoms and their metal salts, disodium perfluorooctanesulfonylglutamate, sodium 3-[omega-fluoroalkyl(C6-C11)oxy]-1-alkyl(C3-C4) sulfonate, sodium-[ω-fluoroalkanoyl(C6-C8)-N-ethylamino]-1-propanesulf onate, fluoroalkyl(C11-C20)carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonylglycin, monoperfluoroalkyl(C6-C16)ethylphosphates, etc.

Specific examples of the marketed products of such surfactants having a fluoroalkyl group include SURFLON S-111, S-112 and S-113, which are manufactured by Asahi Glass Co., Ltd.; FRORARD FC-93, FC-95, FC-98 and FC-129, which are manufactured by Sumitomo 3M Ltd.; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOP EF-102, 103, 104, 105, 112, 123A, 306A, 501, 201 and 204, which are manufactured by Tohchem Products Co., Ltd.; FUTARGENT F-100 and F150 manufactured by Neos; etc.

Specific examples of the cationic surfactants, which can disperse an oil phase including toner constituents in water, include primary, secondary and tertiary aliphatic amines having a fluoroalkyl group, aliphatic quaternary ammonium salts such as erfluoroalkyl(C6-C10)sulfoneamidepropyltrimethylammonium salts, benzalkonium salts, benzetonium chloride, pyridinium salts, imidazolinium salts, etc. Specific examples of the marketed products thereof include SURFLONS-121 (from Asahi Glass Co., Ltd.); FRORARD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos); etc.

The particulate resin is added to the aqueous medium to stabilize mother toner particles therein. Therefore, the particulate resin is preferably added thereto so as to be present on the surface of the mother toner particles with a coverage of from 10 to 90%. Specific examples thereof the particulate polymers include particulate polymethyl methacrylate having a particle diameter of 1 μm and 3 μm, particulate polystyrene having a particle diameter of 0.5 μm and 2 μm, particulate styrene-acrylonitrile copolymers having a particle diameter of 1 μm, PB-200H (from Kao Corp.),

### SGP (Soken Chemical & Engineering Co., Ltd.), TECHNOPOLYMER SB (Sekisui Plastics Co., Ltd.), SPG-3G (Soken Chemical & Engineering Co., Ltd.), and MICROPEARL (Sekisui Fine Chemical Co., Ltd.).

In addition, inorganic compound dispersants such as tricalcium phosphate, calcium carbonate, titanium oxide, colloidal silica and hydroxyapatite which are hardly insoluble in water can also be used.

Further, it is possible to stably disperse toner constituents in the aqueous medium by using a polymeric protection colloid in combination with the particulate resin and/or inorganic dispersants mentioned above. Specific examples of such protection colloids include polymers and copolymers prepared using monomers such as acids (e.g., acrylic acid, methacrylic acid, a-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

The dispersion method is not particularly limited, and low speed shearing methods, high-speed shearing methods, friction methods, high-pressure jet methods, ultrasonic methods, etc. can be used. Among these methods, high-speed shearing methods are preferably used because particles having a particle diameter of from 2 to 20 μm can be easily prepared. At this point, the particle diameter (2 to 20 μm) means a particle diameter of particles including a liquid). When a high-speed shearing type dispersion machine is used, the rotation speed is not particularly limited, but the rotation speed is typically from 1,000 to 30,000 rpm, and preferably from 5,000 to 20,000 rpm. The dispersion time is not also particularly limited, but is typically from 0.1 to 5 minutes. The temperature in the dispersion process is typically from 0 to 150° C. (under pressure), and preferably from 40 to 98° C.

3) While an emulsion is prepared, amines (B) are included therein to be reacted with the polyester prepolymer (A) having an isocyanate group.

This reaction is accompanied by a crosslinking and/or a elongation of a molecular chain. The reaction time depends on reactivity of an isocyanate structure of the prepolymer (A) and amines (B), but is typically from 10 min to 40 hrs, and preferably from 2 to 24 hrs. The reaction temperature is typically from 0 to 150° C., and preferably from 40 to 98° C. In addition, a known catalyst such as dibutyltinlaurate and dioctyltinlaurate can be used.

4) After the reaction is terminated, an organic solvent is removed from an emulsified dispersion (a reactant), which is washed and dried to form a parent toner particle.

The prepared emulsified dispersion (reactant) is gradually heated while stirred in a laminar flow, and an organic solvent is removed from the dispersion after stirred strongly when the dispersion has a specific temperature to form a parent toner particle having the shape of a spindle. When an acid such as calcium phosphate or a material soluble in alkaline is used as a dispersant, the calcium phosphate is dissolved with an acid such as a hydrochloric acid and washed with water to remove the calcium phosphate from the toner particle. Besides this method, it can also be removed by an enzymatic hydrolysis.

5) A charge controlling agent is beat in the parent toner particle, and inorganic particulate materials such as particulate silica and particulate titanium oxide are externally added thereto to form a toner.

Known methods using a mixer, etc. are used to beat in the charge controlling agent and to externally add the inorganic particulate materials.

Thus, a toner having a small particle diameter and a sharp particle diameter distribution can be obtained. Further, the strong agitation in the process of removing the organic solvent can control the shape of a toner from a sphere to a rugby ball, and the surface morphology thereof from being smooth to a pickled plum.

The image forming method of the present invention will be further explained.

[1] First, a toner for use in the image forming method of the present invention preferably includes an external additive having a BET specific surface area of from 0.5 to 3.5 m²/g per unit weight.

A toner typically includes an external additive because of being difficult to use in image forming apparatuses without the external additive. Too much external additive occasionally causes problems of image forming apparatuses. Therefore, the external additive included in a toner per unit weight needs to have a BET specific surface area within the above-mentioned range. This can be controlled by changing the quantity of the external additive to be included according to the BET specific surface area thereof.

[2] Next, chargers for use in the image forming method of the present invention are not particularly limited, but chargers using corona discharge are preferably used.

The chargers using corona discharge typically include corotron chargers and scorotron chargers, and both of them can be used in the present invention. However, the scorotron chargers is preferably used because of being capable of evenly charging the surface of an image bearer and lowering the frequency of abnormal images.

[3] A toner for use in the image forming method of the present invention preferably has a ratio (Dv/Dn) of a volume-average particle diameter (Dv) thereof to a number-average particle diameter thereof (Dn) of from 1.00 to 1.40.

The toner preferably has a volume-average particle diameter (Dv) of from 3.0 to 7.0 μm. Typically, it is said that the smaller the toner particle diameter, the more advantageous to produce high resolution and quality images. However, the small particle diameter of the toner is disadvantageous thereto to have transferability and cleanability. When the volume-average particle diameter is too small, the resultant toner in a two-component developer melts and adheres to a surface of a carrier to deteriorate chargeability thereof when stirred for long periods in an image developer. When the toner is used in a one-component developer, toner filming over a developing roller and fusion bond of the toner to a blade forming a thin layer thereof tend to occur.

A toner having such a ratio (Dv/Dn) produces high-resolution and high-quality images. Further, in a two-component developer, the toner has less variation in the particle diameter even after consumed and fed for long periods, and has good and stable developability even after stirred in an image developer for long periods. When Dv/Dn is greater than 1.40, the particle diameter distribution of the toner becomes flat, resulting in deterioration of reproducibility of a microscopic dot. The toner more preferably has Dv/Dn of from 1.00 to 1.20 to produce better quality images.

The average particle diameter and particle diameter distribution of the toner can be measured by a Coulter counter TA-II, Coulter Multisizer II or Multisizer III from Beckman Coulter, Inc. as follows:

0.1 to 5 ml of a detergent, preferably alkylbenzene sulfonate is included as a dispersant in 100 to 150 ml of the electrolyte ISOTON-II from Coulter Scientific Japan, Ltd., which is a NaCl aqueous solution including an elemental sodium content of 1%;

2 to 20 mg of a toner sample is included in the electrolyte to be suspended therein, and the suspended toner is dispersed by an ultrasonic disperser for about 1 to 3 min to prepare a sample dispersion liquid; and

a volume and a number of the toner particles for each of the following channels are measured by the above-mentioned measurer using an aperture of 100 μm to determine a weight distribution and a number distribution:

2.00 to 2.52 μm; 2.52 to 3.17 μm; 3.17 to 4.00 μm; 4.00 to 5.04 μm; 5.04 to 6.35 μm; 6.35 to 8.00 μm; 8.00 to 10.08 μm; 10.08 to 12.70 μm; 12.70 to 16.00 μm; 16.00 to 20.20 μm; 20.20 to 25.40 μm; 25.40 to 32.00 μm; and 32.00 to 40.30 μm.

[4] A toner for use in the image forming method of the present invention preferably includes particles having a diameter not greater than 2 m in an amount of 1 to 10% by number. The content of fine powders has a large influence on problems due to the particle diameter, and particularly the particles having a diameter not greater than 2 μm in an amount greater than 10% by number are likely to adhere to a carrier and are difficult to have stable chargeability. On the contrary, particles having a diameter greater than 2 μm are difficult to produce high-definition and high-quality images, and the particle diameter of the toner largely varies after consumed from and supplied to a developer in many cases, which is same when Dv/Dn is greater than 1.40.

The content of the toner particles having a diameter not greater than 2 μm and the circularity of the toner is measured by a flow-type particle image analyzer FPIA-2000 from SYSMEX CORPORATION. A specific measuring method includes adding 0.1 to 0.5 ml of a surfactant, preferably an alkylbenzenesulfonic acid, as a dispersant in 100 to 150 ml of water from which impure solid materials are previously removed; adding 0.1 to 0.5 g of the toner in the mixture; dispersing the mixture including the toner with an ultrasonic disperser for 1 to 3 min to prepare a dispersion liquid having a concentration of from 3,000 to 10,000 pieces/μl; and measuring the toner shape and distribution with the above-mentioned measurer.

[5] It is preferable that a particulate material having an average primary particle diameter of from 50 to 500 nm and a bulk density not less than 0.3 g/cm³ is externally added to a toner for use in the image forming method of the present invention.

Such a particulate material as an external additive improves not only the cleanability of the resultant toner, but also the developability and transferability of a toner having a small particle diameter.

The improved cleanability more easily removes discharge products and a toner a deteriorated lubricant is absorbed to. Further, removal of the discharge products and deteriorated lubricant is an extra safety margin against production of abnormal images such as image deletion.

When the average primary particle diameter is less than 50 nm, the particulate material is buried in a concave on the surface of a toner, resulting in lower capability of rolling. When greater than 500 nm, the particulate material positioned between a cleaning blade and a photoreceptor passes a toner, resulting in poor cleaning.

When the bulk density is less than 0.3 mg/cm³, the fluidity of the resultant toner improves, but effects of rolling and a dam effect, i.e., accumulating a toner at a cleaner to prevent poor cleaning deteriorate because the toner and the particulate material have high scattering capability and adherence.

The particulate material includes inorganic compounds such as SiO₂, TiO₂, Al₂O₃, MgO, CuO, ZnO, SnO₂, CeO₂, Fe₂O₃, BaO, CaO, K₂O, Na₂O, ZrO₂, CaO.SiO₂, K₂O(TiO₂)n, Al₂O₃.2SiO₂, CaCO₃, MgCO₃, BaSO₄, MgSO₄ and SrTiO₃, and SiO₂, TiO₂ and Al₂O₃ are preferably used. Particularly, these inorganic compounds may be hydrophobized with various coupling agents, hexamethyldisilazane, dimethyldichlorosilane, octyltrimethoxysilane, etc.

Organic particulate materials can also be used, which include thermoplastic and thermosetting resins such as vinyl resins, polyurethane resins, epoxy resins, polyester resins, polyamide reins, polyimide resins, silicon resins, phenol resins, melamine resins, urea resins, aniline resins, ionomer resins and polycarbonate resins. These can be used alone or in combination. Among these resins, vinyl resins, polyurethane resins, epoxy resins, polyester resins and their combinations are preferably used because an aqueous dispersion including a fine spherical particulate resin can easily be prepared.

Specific examples of the vinyl resins include homopolymerized or copolymerized polymers such as styrene-(metha)esteracrylate resins, styrene-butadiene copolymers, (metha)acrylic acid-esteracrylate polymers, styrene-acrylonitrile copolymers, styrene-maleic acid anhydride copolymers and styrene-(metha)acrylic acid copolymers.

The bulk density of the particulate material is measured by the following method.

The particulate material is gradually placed in a measuring cylinder having a capacity of 100 ml until filled therewith. No oscillation is applied thereto while the particulate material is placed therein. The bulk density is determined by the following formula (3):

Bulk density (g/cm³)=Quantity of particulate material (g/100 ml)/100.

Methods of externally adding the particulate material to adhere to the surface of a toner include a method of mechanically mixing mother toner particles and the particulate material with a known mixer so as to adhere to each other, a method of evenly dispersing mother toner particles and the particulate material with a surfactant in a liquid phase so as to adhere to each other and drying, etc.

[6] An image bearer for use in the image forming method of the present invention is preferably an organic photoreceptor having a surface layer where a filler is dispersed.

The organic photoreceptor having a surface layer where a filler is dispersed has a longer life. Such an image bearer having improved abrasion resistance can keep a flat surface. Therefore, a toner is not trapped on microscopic concavities and convexities on the surface of an image bearer, which can keep cleanability. Further, the cleanability more easily removes discharge products and a toner a deteriorated lubricant is absorbed to, and removal of the discharge products and deteriorated lubricant is an extra safety margin against production of abnormal images such as image deletion.

The photoreceptor having a surface layer where a filler is dispersed is, e.g., a photoreceptor having a protection layer a filler is added in to improve the abrasion resistance. Specific examples of the organic fillers include powders of fluorocarbon resins such as polytetrafluoroethylene, silicone resin powders and a-carbon powders. Specific examples of the inorganic fillers include powders of metals such as copper, tin, aluminum and indium; metal oxides such as silica, tin oxide, zinc oxide, titanium oxide, indium oxide, antimony oxide, bismuth oxide, tin oxide doped with antimony, indium oxide doped with tin and potassium titanate. These fillers can be used alone or in combination. The filler can be dispersed in a protection layer coating liquid by a suitable disperser. The filler preferably has an average particle diameter not greater than 0.5 μm, and more preferably not greater than 0.2 μm in terms of transmission of the protection layer. In addition, a plasticizer and a leveling agent may be added to the protection layer.

[7] An image bearer for use in the image forming method of the present invention is preferably an organic photoreceptor having a protection layer using a crosslinking charge transport material.

A binder formed of a crosslinked structure is effectively used in the protection layer. Reactive monomers having plural crosslinkable functional groups in a molecule are subjected to a crosslinking reaction with a light or a heat energy to form a three-dimensional network, which works as a binder resin and has high abrasion resistance.

In terms of electrical stability, printing resistance and life of the photoreceptor, monomers having charge transportability are very effectively used for all or a part of the reactive monomers. The monomers having charge transportability forms a charge transport site in the network and the protection layer fulfills its function.

The reactive monomers having charge transportability include a compound including at least each one of charge transportable component and silicon atom having a hydrolyzable substituent in the same molecule, a compound including a charge transportable component and a hydroxyl group in the same molecule, a compound including a charge transportable component and a carboxyl group in the same molecule, a compound including a charge transportable component and an epoxy group in the same molecule, a compound including a charge transportable component and an isocyanate group in the same molecule, etc. These charge transportable materials having reactive groups can be used alone in combination.

Reactive monomers having a triarylamine structure is more preferably used as charge transportable monomers because of having high electrical and chemical stability, and high carrier transportability.

Besides, known monofunctional and bifunctional polymerizable monomers, and polymerizable oligomers can be combined for the purpose of controlling viscosity of the coating liquid, reducing stress of crosslinking charge transport layer, lowering surface energy and friction coefficient.

A heat or light polymerizes or crosslinks a positive-hole transportable compound. The heat polymerization needs only a heat or a heat and a polymerization initiator. The initiator is preferably used to effectively polymerize at a lower temperature.

UV light is preferably used for photopolymerization, however, only the light energy hardly performs the photopolymerization and a photopolymerization initiator is typically used together. The photopolymerization initiator mostly absorbs UV having a wavelength not greater than 400 nm and generates an active radical and ion to start polymerization. In the present invention, a thermopolymerization and a photopolymerization may be used together.

Although a charge transport layer having such a network has high abrasion resistance, the layer has a large volume contraction when crosslinked and occasionally has a crack. Therefore, a low-molecular-weight dispersion polymer layer may be formed as an underlayer and a crosslinked layer may be formed as an upperlayer, sandwiching the charge transport layer.

A crosslinked protection layer is formed by the following method.

30 parts by weight of a positive-hole transport compound having the following formula (1) and 0.6 parts by weight of an acrlic monomer having the following formula (2) and a photopolymerization initiator (1-hydroxy-cyclohexyl-phenyl-ketone) are dissolved in a mixed solvent including each 50 parts by weight of monochlorobenzene and dichloromethane to prepare a surface protection layer coating liquid. The coating liquid is coated on a charge transport layer by a spray coating method and is hardened for 30 sec at a light intensity of 500 mW/cm² with a metal halide lamp to form a surface protection layer having a thickness of 5 μm.

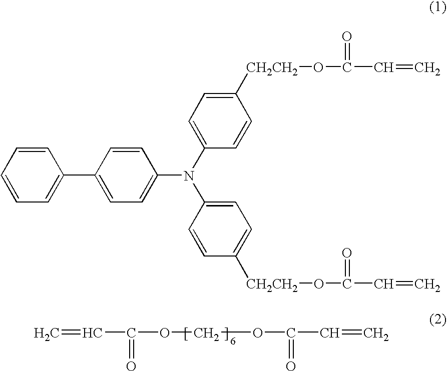

[8] An image bearer for use in the image forming method of the present invention may be an amorphous silicon photoreceptor.

The amorphous silicon photoreceptor (hereinafter referred to as an a-Si photoreceptor) can be used in the present invention. An a-Si photoreceptor can, for example, be formed by heating an electroconductive substrate at from 50 to 400° C. and forming an a-Si photosensitive layer on the substrate by a vacuum deposition method, a sputtering method, an ion plating method, a heat CVD method, a photo CVD method, a plasma CVD method, etc. Particularly, the plasma CVD method is preferably used, which forms an a-Si layer on the substrate by decomposing a gas material with a DC, high-frequency or microwave glow discharge.

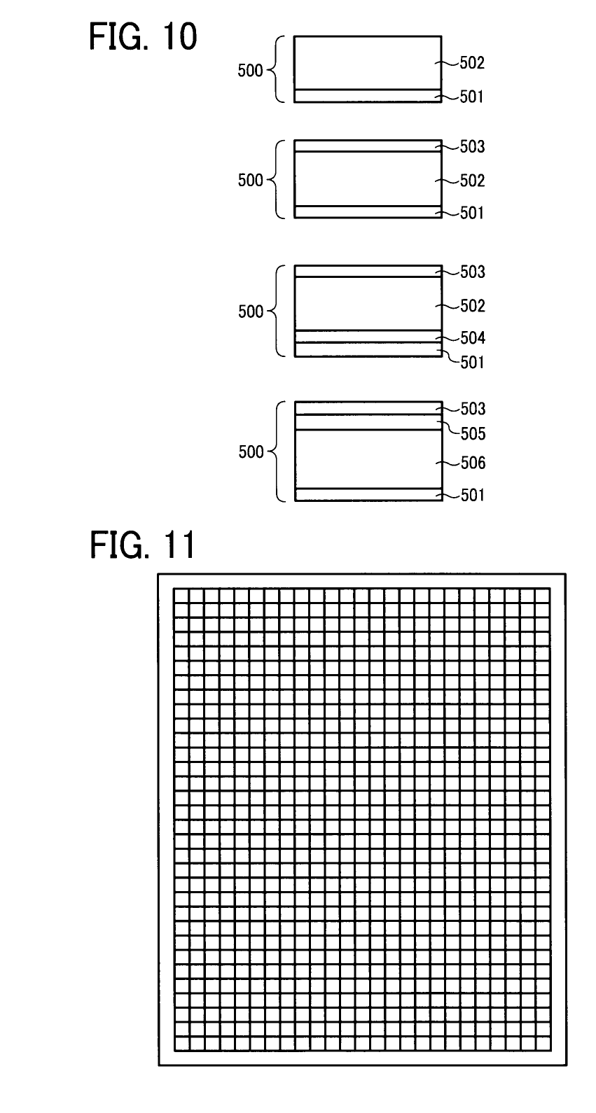

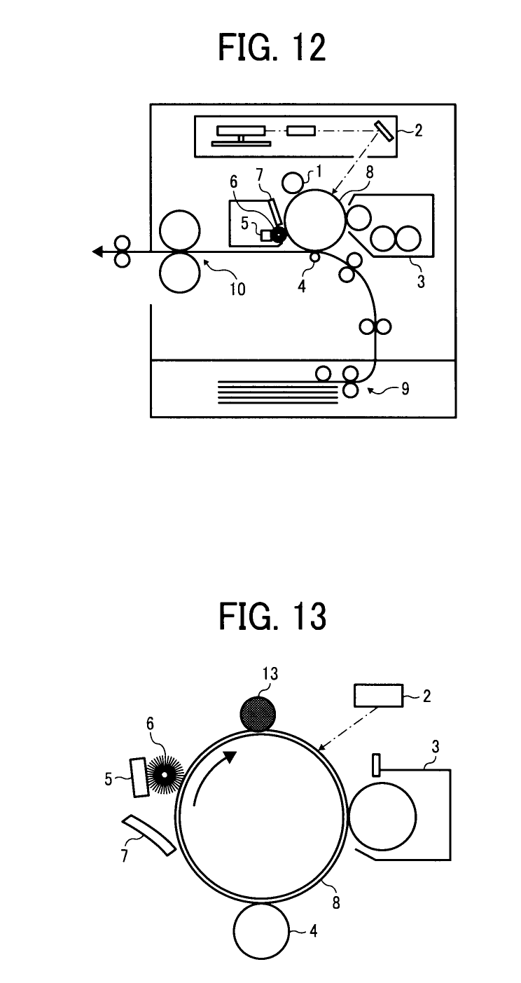

FIG. 10 is a schematic view illustrating (first to fourth) embodiments of layer structures of an amorphous silicon photoreceptor. An electrophotographic photoreceptor 500 in the first embodiment includes a substrate 501 and a photosensitive layer 502 thereon, which is photoconductive and formed of a-Si.

An electrophotographic photoreceptor 500 in the second embodiment includes a substrate 501, a photosensitive layer 502 thereon and an a-Si surface layer 503 on the photosensitive layer 502.

An electrophotographic photoreceptor 500 in the third embodiment includes a substrate 501, a charge injection prevention layer 504 thereon, a photosensitive layer 502 on the charge injection prevention layer 504 and an a-Si surface layer 503 on the photosensitive layer 502.

An electrophotographic photoreceptor 500 in the fourth embodiment includes a substrate 501, a photosensitive layer 502 thereon including a charge generation layer 505 and a charge transport layer formed of a-Si, and an a-Si surface layer 503 on the photosensitive layer 502.

The substrate of the photoreceptor may either be electroconductive or insulative. Specific examples of the substrate include metals such as Al, Cr, Mo, Au, In, Nb, Te, V, Ti, Pt, Pd and Fe and their alloyed metals such as stainless. In addition, insulative substrates such as films or sheets of synthetic resins such as polyester, polyethylene, polycarbonate, cellulose acetate, polypropylene, polyvinylchloride, polystyrene, polyamide; glasses; and ceramics can be used, provided at least a surface of the substrate a photosensitive layer is formed on is treated to be electroconductive.

The substrate has the shape of a cylinder, a plate or an endless belt having a smooth or a concave-convex surface. The substrate can have a desired thickness, which can be as thin as possible when an electrophotographic photoreceptor including the substrate is required to have flexibility. However, the thickness is typically not less than 10 μm in terms of production and handling conveniences, and a mechanical strength of the electrophotographic photoreceptor.

The a-Si photoreceptor of the present invention may optionally include a charge injection prevention layer between the electroconductive substrate and the photosensitive layer in the third embodiment of FIG. 10. When the photosensitive layer is charged with a charge having a certain polarity, the charge injection prevention layer prevents a charge from being injected into the photosensitive layer from the substrate. However, the charge injection prevention layer does not prevent this when the photosensitive layer is charged with a charge having a reverse polarity, i.e., having a dependency on the polarity. The charge injection prevention layer includes more atoms controlling conductivity than the photosensitive layer to have such a capability. The charge injection prevention layer preferably has a thickness of from 0.1 to 5 μm, more preferably from 0.3 to 4 μm, and most preferably from 0.5 to 3 μm in terms of desired electrophotographic properties and economic effects.

The photosensitive layer 502 is formed on an undercoat layer optionally formed on the substrate and has a thickness as desired, and preferably of from 1 to 100 μm, more preferably from 20 to 50 μm, and most preferably from 23 to 45 μm in terms of desired electrophotographic properties and economic effects.

The charge transport layer is a layer transporting a charge when the photosensitive layer is functionally separated. The charge transport layer includes at least a silicon atom, a carbon atom and a fluorine atom, and optionally includes a hydrogen atom and an oxygen atom. Further, the charge transport layer has photosensitivity, charge retainability, charge generation capability and charge transportability as desired. In the present invention, the charge transport layer preferably includes an oxygen atom.

The charge transport layer has a thickness as desired in terms of electrophotographic properties and economic effects, preferably of from 5 to 50 μm, more preferably from 10 to 40 μm, and most preferably from 20 to 30 μm.

The charge generation layer is a layer generating a charge when the photosensitive layer is functionally separated. The charge generation layer includes at least a silicon atom, does not substantially include a carbon atom and optionally includes a hydrogen atom. Further, the charge generation layer 505 has photosensitivity, charge generation capability and charge transportability as desired.

The charge generation layer has a thickness as desired in terms of electrophotographic properties and economic effects, preferably of from 0.5 to 15 μm, more preferably from 1 to 10 μm, and most preferably from 1 to 5 μm.

The a-Si photoreceptor for use in the present invention can optionally include a surface layer on the photosensitive layer located on the substrate, which is preferably an a-Si surface layer. The surface layer has a free surface and is formed to attain objects of the present invention in humidity resistance, repeated use resistance, electric pressure resistance, environment resistance and durability of the photoreceptor.

The surface layer preferably has a thickness of from 0.01 to 3 μm, more preferably from 0.05 to 2 μm, and most preferably from 0.1 to 1 μm. When less than 0.01 μm, the surface layer is lost due to abrasion during use of the photoreceptor. When greater than 3 μm, deterioration of the electrophotographic properties occurs, such as an increase of residual potential of the photoreceptors.

[9] An image forming apparatus using the image forming method of the present invention evenly charges an image forming area on the surface of a cylinder-shaped or a belt-shaped image bearer with a charger; writing on the image bearer with an irradiator to form a latent image; and developing the latent image with a frictionally-charged toner with an image developer to form a visual image. The toner is the water-granulated toner. Next, a transferer directly or indirectly through an intermediate transferer transfers the image onto a recording paper fed from a paper feeder, and then a fixer fixes the image on the recording paper.

On the other hand, a cleaner scrapes off an untransferred toner remaining on the image bearer is scraped off from the image bearer, and the image forming apparatus is ready for the following image forming process after passing these image forming processes.

The image forming apparatus of the present invention has a lubricator applying a lubricant to the image bearer.

The lubricant may be applied either on the upstream or downstream side of the cleaner provided it is applied on the downstream side of the transferer and upstream side of the charger. When it is difficult to evenly apply the lubricant to the image bearer due to a process speed, etc., the lubricant is preferably applied thereto on the downstream side of the cleaner and upstream side of the charger. In addition, the image forming apparatus may have a lubricant evener to improve lubricant application efficiency to the image bearer.

Such image forming apparatuses include apparatuses using a revolver method of having only one image bearer forming each color image and apparatuses using a tandem method of having plural image bearers, each of which forms one color image.

The chargers, as mentioned above, include roller chargers (close-contact chargers) discharging in a micro-space between the chargers and image bearers, and corona chargers not discharging between the chargers and image bearers such as corotron chargers and corotron chargers.

The irradiators include LDs, LED lamps and Xenon lamps.

The image developers use one-component developers and two-component developers including a toner and a carrier, and the toner is the above-mentioned water-granulated toner.

The transferers include transfer belts, transfer chargers and transfer rollers.

The cleaners include blade-shaped cleaning blades formed of polyurethane rubbers, silicone rubbers, nitrile rubbers, chloroprene rubbers, etc. Plural cleaners are occasionally used. In such a case, each of the cleaning blades may have an obtuse edge (90 to 180°) when contacting the image bearer in the counter direction of the rotation direction thereof. Such a cleaning blade increases a contact pressure to an image bearer and improves its cleanability. In addition, a voltage may be applied to the cleaner as well to electrostatically clean a toner on the surface of the image bearer. The cleaning blade may contact the image bearer either in the counter direction or the trail direction of the rotation direction thereof.

When the cleaner insufficiently cleans a toner on an image bearer alone, a cleaning assistor improves the cleanability. The cleaning assistors include fur brushes, elastic rollers, tube-covered rollers, nonwoven clothes, etc. These are occasionally used in combination. A voltage may be applied to the cleaning assistor to control the polarity of a toner for improving the cleanability. In addition, a loop brush having a looped tip may be used.

The lubricators coat a lubricant to an image bearer with fur brushes, loop brushes, rollers and belts, or may directly coating a solid lubricant or a lubricant powder thereto.

Specific examples of the lubricant include powdery, solid or film fluorine-containing resins such as polytetrafluoroethylene and polyvinylidene fluoride; fatty acid metallic salts having a lamella crystal structure such as zinc stearate, magnesium stearate, calcium stearate, lauroyl lysine, monocetylphosphate sodium zinc salts and lauroyltaurinecalcium; liquid materials such as silicone oils, fluorine-containing oils, natural waxes and synthetic waxes; and gaseous materials as externally additives.

When the fatty acid metallic salts are used as a lubricant, an amount thereof satisfying the following formula (4) is preferably coated on an image bearer:

1.52×10−4{Vpp−2Vth}f/v (4)

wherein Vpp is an amplitude [V] of an AC voltage applied to a charger; f is a frequency [Hz] of the AC voltage applied to the charger; v is a traveling speed [mm/sec] of the surface of the image bearer; and Vth is a discharge starting voltage, which equals 312+6.2(d/εopc+Gp/εair)+√(7737.6d/εopc), wherein d [μm] is a layer thickness of the image bearer; Gp [μm] is a minimum distance between the surface of the charger and that of the image bearer; εopc is a relative permittivity; and εair is a relative permittivity at a space between the charger and the image bearer.

Namely, a lubricant is preferably coated on the image bearer such that a ratio [%] of a metallic element included in the fatty acid metallic salts present on the surface of the image bearer is not less than the ratio determined by the formula (4) in a an area of the image bearer charged by the charger when measured by an X-ray photoelectron spectrometer (XPS).

The lubricant eveners include blade-shaped lubricant eveners formed of polyurethane rubbers, silicone rubbers, nitrile rubbers, chloroprene rubbers, etc. The blade may have an obtuse edge (90 to 180°) when contacting the image bearer in the counter direction of the rotation direction thereof. Such a blade increases a contact pressure to an image bearer and improves its evening efficiency. In addition, a voltage may be applied to the evener as well to electrostatically clean a toner having scraped through the cleaner from the surface of the image bearer. The blade may contact the image bearer either in the counter direction or the trail direction of the rotation direction thereof.

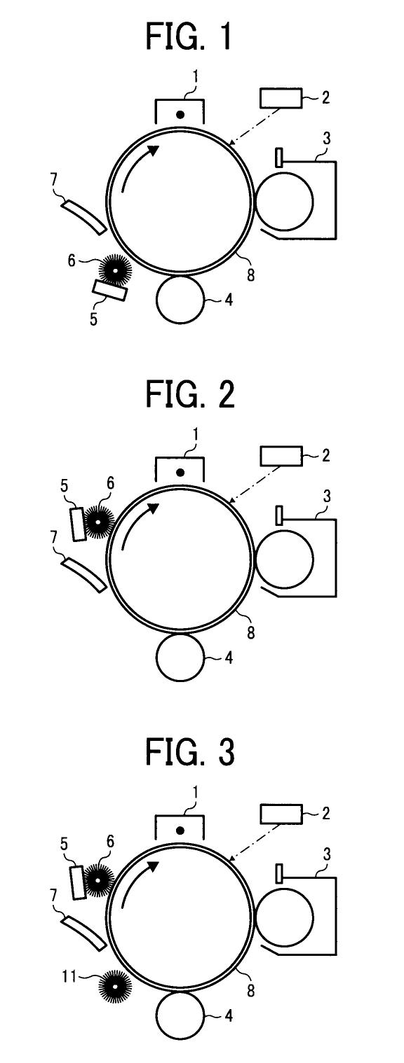

FIGS. 1 to 7 and 13 are schematic views illustrating embodiments of image forming apparatuses using the image forming method of the present invention.

FIG. 1 is an image forming apparatus in which a corona charger (1), an irradiator (2), an image developer (3), a transferer (4), a lubricator (6) having a lubricant (5) and a cleaner (7) are located in this order in the rotation direction of a cylindrical image bearer (8), i.e. an electrophotographic photoreceptor.

FIG. 2 is an image forming apparatus in which a corona charger (1), an irradiator (2), an image developer (3), a transferer (4), a cleaner (7) and a lubricator (6) having a lubricant (5) are located in this order in the rotation direction of a cylindrical image bearer (8).

FIG. 3 is an image forming apparatus in which a corona charger (1), an irradiator (2), an image developer (3), a transferer (4), a brush-shaped cleaning assistor (11), a cleaner (7) and a lubricator (6) having a lubricant (5) are located in this order in the rotation direction of a cylindrical image bearer (8).

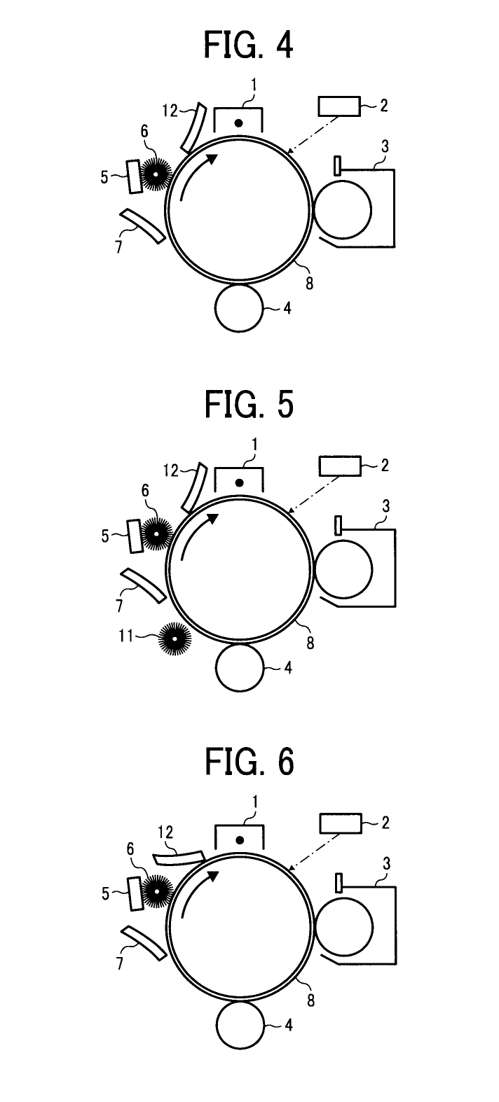

FIG. 4 is an image forming apparatus in which a corona charger (1), an irradiator (2), an image developer (3), a transferer (4), a cleaner (7), a lubricator (6) having a lubricant (5) and a lubricant evener (12) [contacting an image bearer (8) in the counter direction of the rotation direction thereof] are located in this order in the rotation direction of the cylindrical image bearer (8).

FIG. 5 is an image forming apparatus in which a corona charger (1), an irradiator (2), an image developer (3), a transferer (4), a brush-shaped cleaning assistor (11), a cleaner (7), a lubricator (6) having a lubricant (5) and a lubricant evener (12) [contacting an image bearer (8) in the counter direction of the rotation direction thereof ] are located in this order in the rotation direction of the cylindrical image bearer (8).

FIG. 6 is an image forming apparatus in which a corona charger (1), an irradiator (2), an image developer (3), a transferer (4), a cleaner (7), a lubricator (6) having a lubricant (5) and a lubricant evener (12) [contacting an image bearer (8) in the trailing direction of the rotation direction thereof] are located in this order in the rotation direction of the cylindrical image bearer (8).

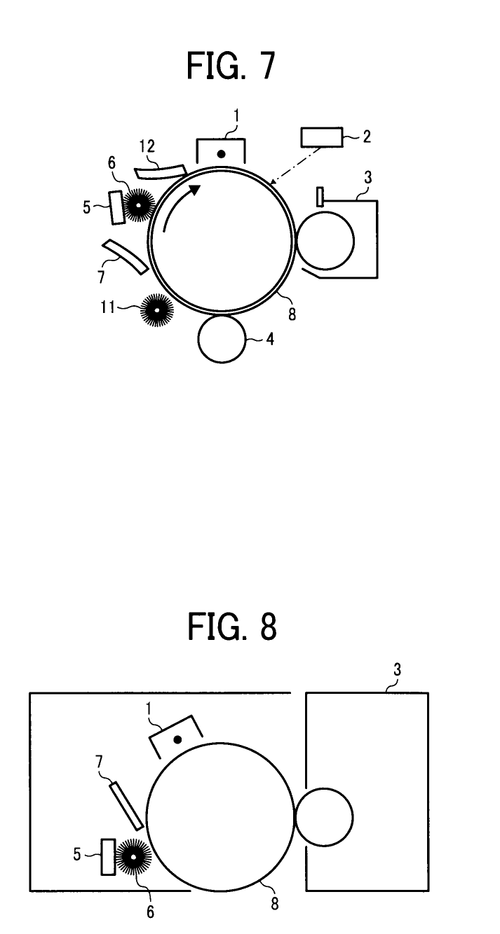

FIG. 7 is an image forming apparatus in which a corona charger (1), an irradiator (2), an image developer (3), a transferer (4), abrush-shaped cleaning assistor (11), a cleaner (7), a lubricator (6) having a lubricant (5) and a lubricant evener (12) [contacting an image bearer (8) in the trailing direction of the rotation direction thereof] are located in this order in the rotation direction of the cylindrical image bearer (8).

FIG. 13 is an image forming apparatus having a charger using a close-contact discharge.

These are revolver-type image forming apparatuses, and may be tandem-type image forming apparatuses.

The image forming apparatuses in FIGS. 1 to 7 use corona chargers not discharging between the chargers and the image bearers, and may use chargers discharging at microscopic spaces between the chargers and the image bearers (using a close-contact discharge).

[10] The image forming apparatuses may include a process cartridge detachable therefrom, including an image bearer (8) and at least one of a charger (1), an image developer (3) and a cleaner (7). It is preferable that the process cartridge is replaced when the image forming apparatus is maintained.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Example 1

### (Synthesis of Unmodified Polyester Resin)

229 parts of an adduct of bisphenol A with 2 moles of ethyleneoxide, 529 parts of an adduct of bisphenol A with 3 moles of propyleneoxide, 208 parts terephthalic acid, 46 parts of adipic acid and 2 parts of dibutyltinoxide were polycondensated in a reactor vessel including a cooling pipe, a stirrer and a nitrogen inlet pipe for 8 hrs at a normal pressure and 230° C. Further, after the mixture was depressurized by 10 to 15 mm Hg and reacted for 5 hrs, 44 parts of trimellitic acid anhydride were added thereto and the mixture was reacted for 2 hrs at a normal pressure and 180° C. to prepare an unmodified polyester resin.

The unmodified polyester resin had a number-average molecular weight of 2,500, a weight-average molecular weight of 6,700, a Tg of 430° C. and an acid value of 25 mg KOH/g.

### (Preparation of Masterbatch)

1,200 parts of water, 540 parts of carbon black Printex 35 from Degussa A.G. having a DBP oil absorption of 42 ml/100 mg and a pH of 9.5, 1,200 parts of the unmodified polyester resin were mixed by a Henschel mixer from Mitsui Mining Co., Ltd. After the mixture was kneaded by a two-roll mill having a surface temperature of 150° C. for 30 min, the mixture was extended by applying pressure, cooled and pulverized by a pulverizer from Hosokawa Micron Limited to prepare a masterbatch.

### (Preparation of Material Solution)

378 parts of the unmodified polyester resin, 110 parts of carnauba wax, 22 parts of a metal complex of salicylic acid E-84 from Orient Chemical Industries Co., Ltd. and 947 parts of ethyl acetate were mixed in a reaction vessel including a stirrer and a thermometer. The mixture was heated to have a temperature of 80° C. while stirred. After the temperature of 80° C. was maintained for 5 hrs, the mixture was cooled to have a temperature of 30° C. in an hour. Then, 500 parts of the masterbatch and 500 parts of ethyl acetate were added to the mixture and mixed for 1 hr to prepare a material solution.

### (Preparation of Wax Dispersion)

1,324 parts of the material solution were transferred into another vessel, and the carbon black and carnauba wax therein were dispersed by a beads mill (Ultra Visco Mill from IMECS CO., LTD.) for 3 passes at a liquid feeding speed of 1 kg/hr and a peripheral disc speed of 6 m/sec using zirconia beads having diameter of 0.5 mm for 80% by volume to prepare a wax dispersion.

### (Preparation of Toner Constituents Dispersion)

Next, 1,324 parts of an ethyl acetate solution of the unmodified polyester resin having a concentration of 65% were added to the wax dispersion. 3 parts of layered inorganic mineral montmorillonite, at least a part of which is modified with a quaternary ammonium salt having a benzyl group, Clayton APA from Southern Clay Products, Inc. were added to 200 parts of the wax dispersion subjected to one pass using the Ultra Visco Mill under the same conditions to prepare a mixture. The mixture was stirred for 30 min with T.K. Homodisper from Tokushu Kika Kogyo Co., Ltd. to prepare a toner constituents dispersion.

### (Preparation of Intermediate Polyester Resin)

682 parts of an adduct of bisphenol A with 2 moles of ethyleneoxide, 81 parts of an adduct of bisphenol A with 2 moles of propyleneoxide, 283 parts terephthalic acid, 22 parts of trimellitic acid anhydride and 2 parts of dibutyltinoxide were mixed and reacted in a reactor vessel including a cooling pipe, a stirrer and a nitrogen inlet pipe for 8 hrs at a normal pressure and 230° C. Further, after the mixture was depressurized by 10 to 15 mm Hg and reacted for 5 hrs to prepare an intermediate polyester resin. The intermediate polyester resin had a number-average molecular weight of 2,100, a weight-average molecular weight of 9,500, a Tg of 55° C. and an acid value of 0.5 mg KOH/g and a hydroxyl value of 51 mg KOH/g.

### (Synthesis of Prepolymer)

Next, 410 parts of the intermediate polyester resin, 89 parts of isophoronediisocyanate and 500 parts of ethyl acetate were reacted in a reactor vessel including a cooling pipe, a stirrer and a nitrogen inlet pipe for 5 hrs at 100° C. to prepare a prepolymer. The prepolymer included a free isocyanate in an amount of 1.53% by weight.

### (Synthesis of Ketimine)

170 parts of isophoronediamine and 75 parts of methyl ethyl ketone were reacted at 50° C. for 5 hrs in a reaction vessel including a stirrer and a thermometer to prepare a ketimine compound. The ketimine compound had an amine value of 418 mg KOH/g.

### (Preparation of Oil Phase Mixed Liquid)

749 parts of the toner constituents dispersion, 115 parts of the prepolymer and 2.9 parts of the ketimine compound were mixed in a vessel by a TK-type homomixer from Tokushu Kika Kogyo Co., Ltd. at 5,000 rpm for 1 min to prepare an oil phase mixed liquid.

### (Preparation of Particulate Resin Dispersion)

683 parts of water, 11 parts of a sodium salt of an adduct of a sulfuric ester with ethyleneoxide methacrylate (ELEMINOL RS-30 from Sanyo Chemical Industries, Ltd.), 83 parts of styrene, 83 parts of methacrylate, 110 parts of butylacrylate and 1 part of persulfate ammonium were mixed in a reactor vessel including a stirrer and a thermometer, and the mixture was stirred for 15 min at 400 rpm to prepare a white emulsion therein. The white emulsion was heated to have a temperature of 75° C. and reacted for 5 hrs. Further, 30 parts of anaqueous solution of persulfate ammonium having a concentration of 1% were added thereto and the mixture was reacted for 5 hrs at 75° C. to prepare a particulate resin dispersion.

### (Preparation of Aqueous Medium)

990 parts of water, 83 parts of the [particulate dispersion liquid], 37 parts of an aqueous solution of sodium dodecyldiphenyletherdisulfonate having a concentration of 48.5% (ELEMINOL MON-7 from Sanyo Chemical Industries, Ltd.), 135 parts of an aqueous solution having a concentration of 1% by weight of a polymer dispersant carboxymethylcellulose sodium Selogen BS-H-3 from DAI-ICHI KOGYO SEIYAKU CO., LTD. and 90 parts of ethyl acetate were mixed and stirred to prepare an aqueous medium.

### (Preparation of Dispersion Slurry)

867 parts of the oil phase mixed liquid was added to 1,200 parts of the aqueous medium and mixed therewith by a TK-type homomixer at 13,000 rpm for 20 min to prepare an emulsion slurry. Next, the emulsion slurry was placed in a vessel including a stirrer and a thermometer. After a solvent was removed from the emulsion slurry at 30° C. for 8 hrs, it was aged at 45° C. for 4 hrs to prepare a dispersion slurry.

### (Washing, Drying and Air Sieving)

After the dispersion slurry was filtered under reduced pressure, 100 parts of ion-exchange water were added to the resultant filtered cake and mixed by the TK-type homomixer at 12,000 rpm for 10 min, and the mixture was filtered.

A hydrochloric acid having a concentration of 10% by weight was added to the filtered cake to have a pH of 2.8 and mixed by the TK-type homomixer at 12,000 rpm for 10 min, and the mixture was filtered.

Further, 300 parts of ion-exchange water were added to the filtered cake and mixed by the TK-type homomixer at 12,000 rpm for 10 min, and the mixture was filtered twice to prepare a final filtered cake.

The final filtered cake was dried by an air drier at 45° C. for 48 hrs and sieved by a mesh having an opening of 75 μm to prepare a mother toner particle.

1.0 part of hydrophobic silica and 0.5 parts of hydrophobized titanium oxide were mixed with 100 parts of the mother toner particle by Henschel Mixer (from Mitsui Mining Co., Ltd.) to prepare a toner. The properties of the toner are shown in Table 1.

### Example 2

The procedures for preparation of the toner in Example 1 were repeated to prepare a toner except for changing 3 parts of the modified and layered inorganic mineral (Clayton APA) into 0.1 parts thereof. The properties of the toner are shown in Table 1.

### Example 3

The procedures for preparation of the toner in Example 1 were repeated to prepare a toner except for changing Clayton APA into layered inorganic mineral montmorillonite, at least a part of which is modified with an ammonium salt having a polyoxyethylene group, Clayton HY from Southern Clay Products, Inc. The properties of the toner are shown in Table 1.

### Example 4

The procedures for preparation of the toner in Example 1 were repeated to prepare a toner except for changing 3 parts of the modified and layered inorganic mineral (Clayton APA) into 1.4 parts thereof. The properties of the toner are shown in Table 1.

### Example 5

The procedures for preparation of the toner in Example 1 were repeated to prepare a toner except for changing 3 parts of the modified and layered inorganic mineral (Clayton APA) into 6 parts thereof. The properties of the toner are shown in Table 1.

### Comparative Example 1

The procedures for preparation of the toner in Example 1 were repeated to prepare a toner except for excluding the modified and layered inorganic mineral (Clayton APA). The properties of the toner are shown in Table 1.

### Comparative Example 2

The procedures for preparation of the toner in Example 1 were repeated to prepare a toner except for changing 3 parts of the modified and layered inorganic mineral (Clayton APA) into 10 parts thereof. The toner constituents dispersion had such a high viscosity that the toner constituents dispersion could not be emulsified and dispersed to prepare a toner.

### Comparative Example 3

The procedures for preparation of the toner in Example 1 were repeated to prepare a toner except for changing 3 parts of the modified and layered inorganic mineral (Clayton APA) into 3 parts of an unmodified layered inorganic mineral montmorillonite (Kunipia from KUNIMINE INDUSTRIES, CO., LTD.). The properties of the toner are shown in Table 1.

### Comparative Example 4

The procedures for preparation of the toner in Example 1 were repeated to prepare a toner except for changing 3 parts of the modified and layered inorganic mineral (Clayton APA) into 1 part of an unmodified layered inorganic mineral montmorillonite (Kunipia from KUNIMINE INDUSTRIES, CO., LTD.). The properties of the toner are shown in Table 1.

Evaluations 1 and 2 of the toners prepared in Examples 1 to 5 and Comparative Examples 1, 3 and 4 were performed based on the following conditions (1) to (11). The results are shown in Table 1. In columns of the evaluations 1 and 2, the above is about abnormal images and the below is about filming. The volume-average particle diameter (Dv) and the number-average particle diameter (Dn) were measured by Multisizer III from Beckman Coulter, Inc. using an aperture of 100 μm. An analysis software Beckman Multisizer 3 Version 3.51 was used. Specifically, 0.5 g of the toner and 0.5 ml of a surfactant (alkylbenzenesulfonate Neogen SC-A from Dai-ichi Kogyo Seiyaku Co., Ltd.) having a concentration of 10% by weight were mixed with a micro spatel in a glass beaker having a capacity of 100 ml, and 80 ml of ion-exchange water was added to the mixture. The mixture was dispersed by an ultrasonic disperser W-113MK-II from HONDA ELECTRONICS CO., LTD. for 10 min. The dispersion was measure by Multisizer III using ISOTON III as a measurement solution from Beckman Coulter, Inc. The dispersion was dropped such that Multisizer III displays a concentration of 8±2%, which is essential in terms of measurement reproducibility of the particle diameter. The particle diameter has no accidental error in the range of the concentration.

### Evaluation 1

(1) The toners and apparatus for use in Examples and Comparative Examples were left in an environmental chamber of 25° C. and 50% Rh for one day;

(2) a process cartridge unit (PCU) installed in a copier Imagio neo C600 from Ricoh Company, Ltd. was modified to charge the image bearer with a corona charger, clean the surface thereof with a cleaning blade and apply a lubricant with a lubricator, and further the image bearer was replaced with an image bearer, the surface of which was not reinforced with a filler;

(3) the cleaning blade had an elasticity of 70% and a thickness of 2 mm, and contacted the image bearer at an angle of 20° in the counter direction of the rotation direction thereof;

(4) a toner in the PCU was all removed and only a carrier was left in the image developer;

(5) 28 g of a sample black toner were placed in the image developer including only the carrier to prepare 400 g of developers having a toner concentration of 7% therein;

(6) the modified PCU was installed in the imagio neo C600, and only the image developer was idled for 5 min at a developing sleeve linear speed of 300 mm/s;

(7) both the developing sleeve and the image bearer were rotated at 300 mm/s in the trailing direction of the rotation direction of the image bearer, and a potential and developing bias were controlled such that a toner on the image bearer had an amount of 0.6±0.05 mg/cm²;

(8) a transfer current was controlled such that a rate of transfer was 96±2%;

(9) 1,000 copies of thin line image in FIG. 11 were produced;

(10) the last image was visually evaluated whether it was an abnormal image;

(11) abnormal images were ×, and not abnormal images were ◯;

(12) in addition, the image bearers after producing 1,000 copies were visually observed whether they were filmed, and the filmed was × and not filmed was ◯.

### Evaluation 2

The procedures of Evaluation 1 were repeated except for using a close-contact discharging charger originally installed in Imagio neo C600.

### Example 6

The procedures of Evaluations 1 and 2 were repeated except for replacing the image bearer with an image bearer having a surface layer in which a filler (alumina having an average primary particle diameter about 300 nm) was dispersed, using the toner prepared in Example 1. The results are shown in Table 1.

### Example 7

The procedures of Evaluations 1 and 2 were repeated except for replacing the image bearer with an image bearer having a protection layer including a crosslinked charge transport material (poly-N-vinylcarbazole) and an acrylic resin as a binder resin, using the toner prepared in Example 1. The results are shown in Table 1.

TABLE 1

| | 2.0 μm | Dv | Dn | Dv/Dn | SF-1 | SF-2 | BET | E1 | E2 |
|---|---|---|---|---|---|---|---|---|---|
| Example 1 | 9.7 | 5.3 | 4.6 | 1.16 | 134 | 127 | 2.56 | ◯ | ◯ |
| | | | | | | | | ◯ | ◯ |
| Example 2 | 6.5 | 5.5 | 4.4 | 1.25 | 147 | 121 | 2.74 | ◯ | ◯ |
| | | | | | | | | ◯ | ◯ |
| Example 3 | 5.4 | 5.0 | 4.3 | 1.16 | 151 | 123 | 4.99 | ◯ | ◯ |
| | | | | | | | | ◯ | ◯ |
| Example 4 | 8.9 | 5.2 | 4.2 | 1.24 | 155 | 127 | 5.85 | ◯ | ◯ |
| | | | | | | | | ◯ | ◯ |
| Example 5 | 3.7 | 5.5 | 4.6 | 1.20 | 145 | 131 | 6.88 | ◯ | ◯ |
| | | | | | | | | ◯ | ◯ |
| Example 6 | 9.7 | 5.3 | 4.6 | 1.16 | 134 | 127 | 2.56 | ◯ | ◯ |
| | | | | | | | | ◯ | ◯ |
| Example 7 | 9.7 | 5.3 | 4.6 | 1.16 | 134 | 127 | 2.56 | ◯ | ◯ |
| | | | | | | | | ◯ | ◯ |
| Comparative | 1.3 | 5.4 | 4.9 | 1.10 | 112 | 104 | 1.84 | X | X |
| Example 1 | | | | | | | | ◯ | ◯ |
| Comparative | 8.4 | 5.1 | 3.5 | 1.46 | 164 | 141 | 7.65 | ◯ | ◯ |
| Example 2 | | | | | | | | X | X |
| Comparative | 0.7 | 8.3 | 7.6 | 1.09 | 137 | 117 | 3.44 | ◯ | ◯ |
| Example 3 | | | | | | | | X | X |

2.0 μm: the content of particles having a particle diameter of 2.0 μm or less
BET: BET specific surface area
E1: Evaluation 1
E2: Evaluation 2

Table 1 proves that a toner having a volume-average particle diameter of from 3.0 to 7.0 μm, an average shape factor SF-1 of from 120 to 160, an average shape factor SF-2 of from 100 to 140 and a BET specific surface area of from 2.5 to 7.0 m²/g has no problem about image quality and filming. This is because a specific BET specific surface area is necessary to remove a lubricant from the surface of an image bearer. When too large, microscopic concavities and convexities on the surface of the toner are crushed, and a part of the lubricant adheres to the surface of the image bearer, resulting in filming.

On the other hand, when the close-discharging chargers were used, the results were the same.

This application claims priority and contains subject matter related to Japanese Patent Applications Nos. 2007-234038 and 2008-180505, filed on Sep. 10, 2007, and Jul. 10, 2008, respectively, the entire contents of each of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the UNITED STATES is:

1. An image forming method, comprising:
charging the surface of an image bearer with a charger;
irradiating the charged surface of the image bearer to form a latent image;
developing the latent image with a toner to form a visible toner image;
transferring the toner image onto a transfer medium directly or through an intermediate transferer;
removing the toner remaining on the surface of the image bearer with a cleaning blade;
applying a lubricant to the surface of the image bearer; and
fixing the toner image on the transfer medium,
wherein the toner is a water-granulated toner having the following properties (1) to (4):
(1) a volume-average particle diameter of from 3.0 to 7.0 μm;
(2) an average shape factor SF-1 of from 120 to 160;
(3) an average shape factor SF-2 of from 100 to 140; and
(4) a BET specific surface area of from 2.5 to 7.0 m²/g.

2. The image forming method of claim 1, wherein the step of charging the surface of the image bearer does not include discharging at a microscopic space between the charger and the image bearer.

3. The image forming method of claim 1, wherein the water-granulated toner has a volume-average particle diameter of from 3.0 to 5.5 μm.

4. The image forming method of claim 1, wherein the water-granulated toner has a volume-average particle diameter of from 5.0 to 5.5 μm.

5. The image forming method of claim 1, wherein the charger is a corona discharger.

6. The image forming method of claim 1, wherein the water-granulated toner comprises:
mother toner particles comprising a binder resin, a colorant and a layered inorganic mineral, the metallic cation of which is at least partially modified with an organic cation; and
an external additive.

7. The image forming method of claim 6, wherein the external additive included in the toner per a unit weight has a BET specific surface area of from 0.5 to 3.5 m²/g.

8. The image forming method of claim 1, wherein the toner has a ratio (Dv/Dn) of the volume-average particle diameter (Dv) to a number-average particle diameter (Dn) of from 1.00 to 1.40.

9. The image forming method of claim 1, wherein the toner comprises particles having a particle diameter not greater than 2 μm in an amount of from 1 to 10% by number.

10. The image forming method of claim 6, wherein the e external additive is particulate material having an average primary particle diameter of from 50 to 500 nm and a bulk density not less than 0.3 g/cm³.

11. The image forming method of claim 1, wherein the image bearer is an organic photoreceptor having a surface layer comprising a dispersed filler.

12. The image forming method of claim 1, wherein the image bearer is an organic photoreceptor having a protection layer comprising a crosslinked charge transport material, a filler or a combination thereof.

13. The image forming method of claim 1, wherein the image bearer is an amorphous silicon photoreceptor.

14. An image forming apparatus, comprising:
an image bearer;
a charger configured to charge the surface of the image bearer;
an irradiator configured to irradiate the image bearer to form a latent image thereon;
an image developer configured to develop the latent image with a toner to form a visible toner image;
a transferer configured to transfer the toner image onto a transfer medium directly or through an intermediate transferer;
a cleaner configured to remove the toner remaining on the surface of the image bearer with a cleaning blade;
a lubricator configured to apply a lubricant to the surface of the image bearer; and
a fixer configured to fix the toner image on the transfer medium,
wherein the toner is a water-granulated toner having the following properties (1) to (4):
(1) a volume-average particle diameter of from 3.0 to 7.0 μm;
(2) an average shape factor SF-1 of from 120 to 160;
(3) an average shape factor SF-2 of from 100 to 140; and
(4) a BET specific surface area of from 2.5 to 7.0 m²/g.

15. The image forming apparatus of claim 14, wherein the charger does not discharge at a microscopic space between the charger and the image bearer.

16. The image forming apparatus of claim 14, wherein the water-granulated toner has a volume-average particle diameter of from 3.0 to 5.5 μm.

17. The image forming apparatus of claim 14, wherein the water-granulated toner has a volume-average particle diameter of from 5.0 to 5.5 μm.

18. A process cartridge, comprising an image bearer and at least one member selected from the group consisting of chargers, image developers and cleaners, wherein the process cartridge is detachable from the image forming apparatus according to claim 1.
